(19) United States
(12) Patent Application Publication
(10) Pub. No.: US 2013/0157518 A1
(43) Pub. Date: Jun. 20, 2013

(54) ELECTRICAL CONNECTOR

(71) Applicant: Yong Fu Wang, Guangzhou (CN)

(72) Inventor: Yong Fu Wang, Guangzhou (CN)

(73) Assignee: LOTES CO., LTD., Keelung (TW)

(21) Appl. No.: 13/399,081

(22) Filed: Feb. 17, 2012

(30) Foreign Application Priority Data
Dec. 14, 2011 (CN) 201120520132.9

(51) Int. Cl. H01R 13/10

(52) U.S. Cl. 439/682

(57) ABSTRACT

An electrical connector includes an insulating body having a plurality of receiving slots and a plurality of terminals respectively fixed in the insulating body. Each of the terminals has a base at least partially disposed in the receiving slot, at least one contact arm, a first fixing portion and an extending arm extending laterally from the base, and a second fixing portion. The first fixing portion fastens the insulating body. A soldering portion is disposed on the extending arm. The second fixing portion selectively extends from the extending arm or the soldering portion and fastens the insulating body. A distance between the second fixing portion and the soldering portion is shorter than that between the first fixing portion and the soldering portion.

### CROSS-REFERENCE TO RELATED APPLICATION

This non-provisional application claims priority under 35 U.S.C. §119(a) on Patent Application No. 201120520132.9 filed in P.R. China on Dec. 14, 2011, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to an electrical connector, and more particularly to an electrical connector capable of improving the soldering effect.

### BACKGROUND OF THE INVENTION

Along with the miniaturization of electronic products, the volume of electrical connectors disposed therein also decreases accordingly, and while maintaining or enhancing the existing transmission effect of the electrical connector, terminals in the electrical connector will inevitably be arranged more densely in space.

A common electrical connector includes an insulating body, and a plurality of terminals received therein. Each of the terminals includes a base, an elastic arm extending laterally from a top end of the base, a contact portion disposed at one end of the elastic arm, a fixing portion extending laterally from the base and used to fix the terminal into the insulating body, and a soldering portion extending from a bottom end of the base. For the convenience of processing and molding, the terminals have the same structure. As the terminals are arranged densely, the distance between the soldering portions becomes very small. When the electrical connector needs to be soldered to a circuit board, the soldering portions need to be correspondingly soldered to a plurality of solder joints of the circuit board and false soldering or contact between two neighboring soldering portions easily occurs, resulting in a short circuit problem.

To solve the above problems, the technical personnel in the industry have thought of disposing the soldering portions in a staggered manner, in which the bases of a part of the terminals respectively extend laterally to form an extending arm, and the soldering portions of the part of the terminals are disposed on the extending arms. By using the extending arm, the soldering portion disposed on the extending arm is staggered from the soldering portion directly disposed on the base.

Such type of a design may avoid the problem of false soldering or short circuit between two neighboring soldering portions. However, as the soldering portion is disposed to extend from the extending arm, the fixation of the terminal inside the insulating body relies on the fixing portion, and the fixing portion is disposed on the base, the extending arm easily shakes to further cause a displacement of the soldering portion when the electrical connector is soldered to the circuit board. Thus the coplanarity of the soldering portions cannot be ensured, resulting in missing solder or false soldering.

Therefore, a heretofore unaddressed need exists in the art to address the aforementioned deficiencies and inadequacies.

### SUMMARY OF THE INVENTION

In one aspect, the present invention is directed to an electrical connector capable of improving coplanarity of soldering portions.

In one embodiment, an electrical connector according to the present invention includes: an insulating body, provided with a plurality of receiving slots, and a plurality of terminals, respectively fixed in the insulating body. Each of the terminals has a base at least partially disposed in the receiving slot, at least one contact arm, a first fixing portion and an extending arm extending laterally from the base, and a second fixing portion. The first fixing portion fastens the insulating body. A soldering portion is disposed on the extending arm. The second fixing portion selectively extends from the extending arm or the soldering portion and fastens the insulating body. A distance between the second fixing portion and the soldering portion is shorter than that between the first fixing portion and the soldering portion.

Further, a guide groove connected with the receiving slot is formed at a bottom of the insulating body corresponding to the extending arm, and the extending arm is received in the guide groove. A first fixing hole is formed from the receiving slot from back to front to match and fix the first fixing portion. A second fixing hole is formed from the guide groove from back to front to match and fix the second fixing portion. An inner wall of the second fixing hole is formed with at least one first chamfer gradually shrinking from an opening towards the inside of the second fixing hole, and the first chamfer correspondingly matches a second chamfer disposed on the second fixing portion. An acute angle exists between the second fixing portion and the soldering portion. The second chamfer is located on an upper surface of the second fixing portion. The first chamfer is disposed in the second fixing hole corresponding to the second chamfer. The first chamfer and the second chamfer conform to and contact each other. The second fixing portion is located above the soldering portion and parallel to the soldering portion. The first fixing portion and the extending arm extend in the same direction. The insulating body has a protruding block located between and contacting the second fixing portion and the soldering portion. The second fixing portion is disposed to extend from an extending direction of the extending arm, and the soldering portion is bent and extends downwards from the extending arm.

As compared with related art, in the electrical connector according to the embodiments of the present invention, among other things, the second fixing portion selectively extends from the soldering portion or the extending arm and fastens the insulating body, and the soldering portion is disposed on the extending arm, so that the second fixing portion may prevent the extending arm from shaking to further avoid a displacement of the soldering portion, so as to achieve the coplanarity of the soldering portions, thereby preventing missing solder or false soldering.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a partial three-dimensional assembled view of an electrical connector according one embodiment of the present invention;

FIG. 2 is a partial exploded view of the electrical connector according to one embodiment of the present invention;

FIG. 3 is a side view of the electrical connector according to one embodiment of the present invention;

FIG. 4 is a partial enlarged view of the electrical connector according to one embodiment of the present invention before the second fixing portion enters the second fixing hole;

FIG. 5 is a partial enlarged view of the electrical connector according to one embodiment of the present invention when the second fixing portion is located in the second fixing hole;

FIG. 6 is a partial enlarged view of an electrical connector according to another embodiment of the present invention in which the second fixing portion extends from the soldering portion; and

FIG. 7 is a schematic view of an electrical connector according to another embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

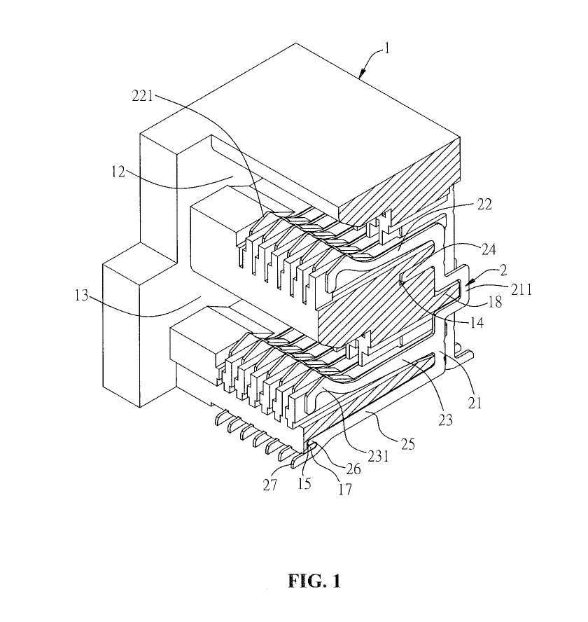

Referring to FIG. 1, an electrical connector includes an insulating body 1, and a plurality of terminals 2 fixed in the insulating body 1.

Referring now to FIGS. 1-3, the insulating body 1 has a first slot 12 and a second slot 13 formed from front to back. The first slot 12 is located above the second slot 13. The insulating body 1 has a plurality of receiving slots 11, and all of the receiving slots 11 are formed from the insulating body 1 from back to front. A first fixing hole 14 extends from the receiving slot 11 from back to front. A guide groove 16 is formed at a bottom of the receiving slot 11 from back to front. A second fixing hole 15 is formed from the guide groove 16 from back to front. The insulating body 1 has a protruding block 17 located below the second fixing hole 15. The insulating body 1 has a bump 18 located between the first fixing hole 14 and the second fixing hole 15 and at least partially located in the receiving slot 11.

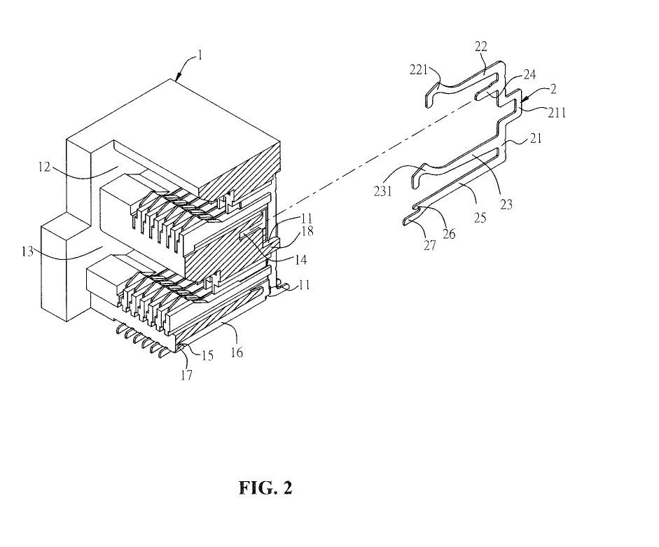

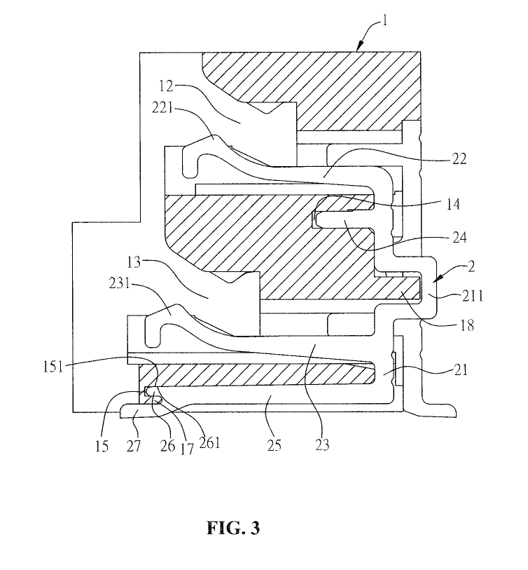

Referring to FIG. 2 and FIG. 3, each of the terminals 2 has a base 21 at least partially disposed in the receiving slot 11. A first contact arm 22 and a second contact arm 23 extend laterally from the base 21 and respectively locate in the insulating body 1. The second contact arm 23 is located below the first contact arm 22. A first contact portion 221 exposed to the first slot 12 is disposed at one end of the first contact arm 22. A second contact portion 231 exposed to the second slot 13 is disposed at one end of the second contact arm 23. A first fixing portion 24 extends laterally from the base 21 to match and be fixed to the first fixing hole 14 by an interference fit. Alternatively, in other embodiments, the first fixing portion 24 may form a non-interference fit with the first fixing hole 14. The bump 18 is located between the first fixing portion 24 and the second contact arm 23, and the first fixing portion 24 is located between the first contact arm 22 and the second contact arm 23.

Referring to FIG. 2 and FIG. 3, an extending arm 25 extends laterally from the base 21 and is located below the second contact arm 23. The extending arm 25 is received in the guide groove 16. The extending arm 25 and the first fixing portion 24 extend in the same direction, or may extend in different directions in other embodiments. A soldering portion 27 and a second fixing portion 26 respectively extend from the extending arm 25. The second fixing portion 26 is disposed to extend from an extending direction of the extending arm 25 and is located above the soldering portion 27. The soldering portion 27 is bent and extends downwards from the extending arm 25. The protruding block 17 is located between and contacts the second fixing portion 26 and the soldering portion 27. The guide groove 16 extends forwards to form the second fixing hole 15 which matches and is fixed to the second fixing portion 26 by an interference fit. The second fixing portion 26, the soldering portion 27 and the first fixing portion 24 are parallel to one another, or may not be parallel to one another in other embodiments. A distance between the second fixing portion 26 and the soldering portion 27 is shorter than that between the first fixing portion 24 and the soldering portion 27. That is, the minimum distance between the first fixing portion 24 and the soldering portion 27 is larger than that between the second fixing portion 26 and the soldering portion 27.

Referring to FIG. 3, a bending portion 211 is formed on the base 21 between the first fixing portion 24 and the second contact arm 23 by bending along the bump 18, and used to stop the base 21, so as to prevent excessive displacement of the terminal 2 in the vertical direction.

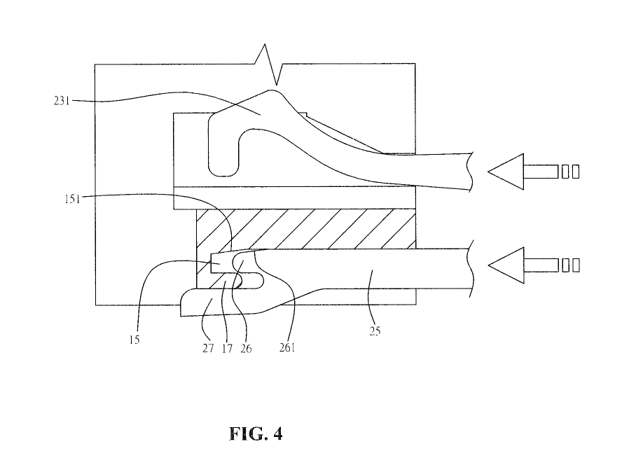

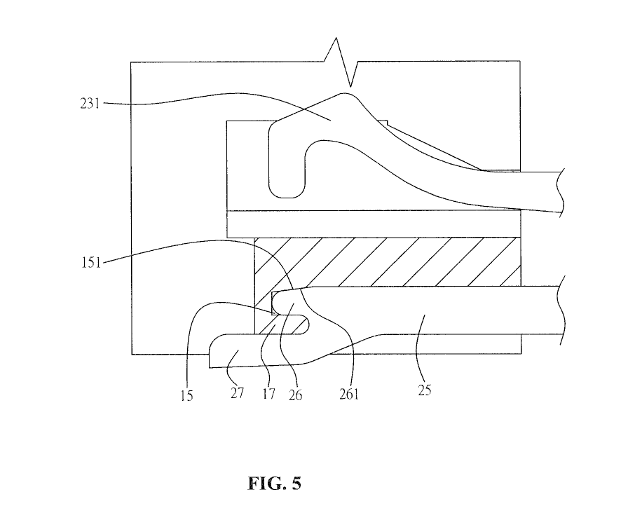

Referring to FIGS. 3-5, an inner wall of the second fixing hole 15 is formed with a first chamfer 151 gradually shrinking from the opening towards the inside of the second fixing hole 15. The first chamfer 151 correspondingly conforms to and contacts a second chamfer 261 disposed on the second fixing portion 26. An acute angle exists between the second fixing portion 26 and the soldering portion 27. The second chamfer 261 is located on an upper surface of the second fixing portion 26. The first chamfer 151 is disposed in the second fixing hole 15 corresponding to the second chamfer 261, and a lower surface of the second fixing portion 26 is horizontally disposed. When the second fixing portion 26 is completely located in the second fixing hole 15, the first chamfer 151 and the second chamfer 261 conform to and contact each other, and the contact position between the second fixing hole 15 and the lower surface of the second fixing portion 26 is also horizontally disposed. In other embodiments, the second chamfer 261 is disposed on the lower surface of the second fixing portion 26, the upper surface of the second fixing portion 26 is horizontally disposed, the second fixing hole 15 is provided with the first chamfer 151 corresponding to the second chamfer 261 to conform to and contact the second chamfer 261, and the contact position between the second fixing hole 15 and the upper surface of the second fixing portion 26 is also horizontally disposed. Alternatively, both the upper surface and the lower surface of the second fixing portion 26 are provided with the second chamfers 261, and the second fixing hole 15 is provided with two first chamfers 151 corresponding to the two second chamfers 261 to respectively conform to and contact the two second chamfers 261.

Referring to FIGS. 1 and 3-5, during assembly, first, the terminals 2 are respectively installed in the receiving slots 11 from back to front. The first contact portion 221 is exposed to the first slot 12, the second contact portion 231 is exposed to the second slot 13, the first fixing portion 24 is fixed in the first fixing hole 14 by an interference fit, the bump 18 is located in the bending portion 211, the extending arm 25 is located in the guide groove 16. When the second fixing portion 26 begins to enter the second fixing hole 15, a gap exists between the second chamfer 261 and the first chamfer 151, so that the second fixing portion 26 is easily installed in the second fixing hole 15 without scratching the second fixing hole 15. When the second fixing portion 26 is completely installed in the second fixing hole 15, no gap exists between the second chamfer 261 disposed on the upper and lower surfaces of the second fixing portion 26 and the first chamfer 151 correspondingly disposed on the inner wall of the second fixing hole 15, so that the second fixing portion 26 is fastened in the second fixing hole 15 more firmly. The protruding block 17 is fixed between the second fixing portion 26 and the soldering portion 27 to prevent downward movement of the second fixing portion 26 and upward movement of the soldering portion 27, thereby enhancing the effect of fixing the soldering portion 27 by the second fixing portion 26.

After assembly, the electrical connector is mounted on a circuit board (not shown). The soldering portion 27 is soldered to the circuit board, and then electrically conducted with two electronic elements (not shown). The two electronic elements are respectively inserted into the first slot 12 and the second slot 13, and respectively conducted with the first contact portion 221 and the second contact portion 231.

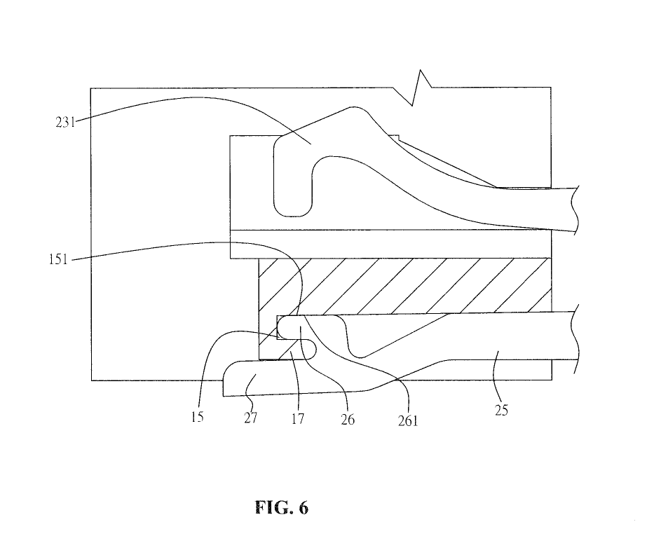

Referring to FIG. 6, in other embodiments, the positional relationship between the second fixing portion 26, the soldering portion 27 and the extending arm 25 may be that, the soldering portion 27 is disposed to extend from the extending arm 25, and the second fixing portion 26 is disposed to extend from the soldering portion 27.

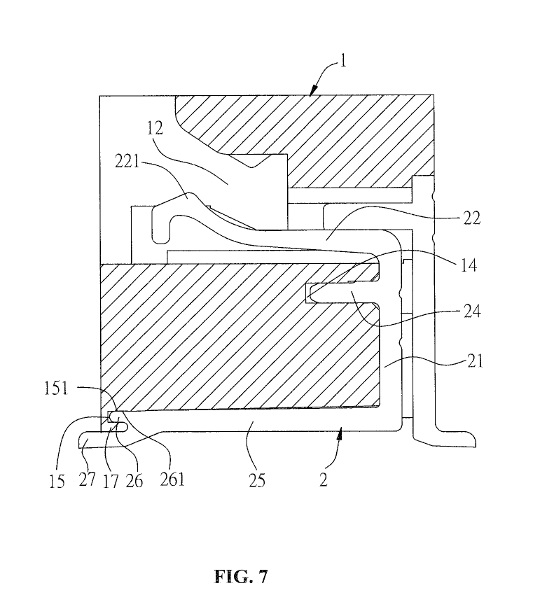

Referring to FIG. 7, another embodiment of the present invention is disclosed, which is different from the above embodiments in that, only the first slot 12 is formed in the insulating body 1, and each of the terminals 2 only includes the first contact arm 22.

Based on the above description, the electrical connector according to the embodiments of the present invention, among other things, has the following beneficial effects.

1. In the electrical connector of the present invention, the second fixing portion 26 selectively extends from the soldering portion 27 or the extending arm 25 and fastens the insulating body 1. The soldering portion 27 is disposed on the extending arm 25, so that the second fixing portion 26 may prevent the extending arm 25 from shaking to further avoid displacement of the soldering portion 27, so as to achieve the coplanarity of the soldering portions 27, thereby preventing missing solder or false soldering.

2. When the second fixing portion 26 begins to enter the second fixing hole 15, a gap exists between the second chamfer 261 and the first chamfer 151, so that the second fixing portion 26 is easily installed in the second fixing hole 15 without scratching the second fixing hole 15. When the second fixing portion 26 is completely installed in the second fixing hole 15, no gap exists between the second chamfer 261 and the first chamfer 151, so that the second fixing portion 26 is fastened in the second fixing hole 15 more firmly.

3. The protruding block 17 is fixed between and contacts the second fixing portion 26 and the soldering portion 27 to prevent downward movement of the second fixing portion 26 and upward movement of the soldering portion 27, thereby enhancing the effect of fixing the soldering portion 27 by the second fixing portion 26.

4. The bending portion 211 is formed on the base 21 between the first fixing portion 24 and the second contact arm 23 by bending along the bump 18, and used to stop the base 21, so as to prevent excessive displacement of the terminal 2 in the vertical direction.

5. The second fixing portion 26 and the soldering portion 27 are parallel to each other and both are disposed to extend forwards, and therefore may be conveniently installed in the insulating body 1 from back to front.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
(a) an insulating body, provided with a plurality of receiving slots; and
(b) a plurality of terminals, respectively fixed in the insulating body, each of the terminals having a base at least partially disposed in the receiving slot, at least one contact arm, a first fixing portion and an extending arm extending laterally from the base, and a second fixing portion, wherein the first fixing portion fastens the insulating body, a soldering portion is disposed on the extending arm, the second fixing portion selectively extends from the extending arm or the soldering portion and fastens the insulating body, and a distance between the second fixing portion and the soldering portion is shorter than that between the first fixing portion and the soldering portion.

2. The electrical connector according to claim 1, wherein a guide groove connected with the receiving slot is formed at a bottom of the insulating body corresponding to the extending arm, and the extending arm is received in the guide groove.

3. The electrical connector according to claim 2, wherein a first fixing hole is formed from the receiving slot from back to front to match and fix the first fixing portion, and a second fixing hole is formed from the guide groove from back to front to match and fix the second fixing portion.

4. The electrical connector according to claim 3, wherein an inner wall of the second fixing hole is formed with at least one first chamfer gradually shrinking from an opening towards the inside of the second fixing hole, and the first chamfer correspondingly matches a second chamfer disposed on the second fixing portion.

5. The electrical connector according to claim 4, wherein an acute angle exists between the second fixing portion and the soldering portion, the second chamfer is located on an upper surface of the second fixing portion, and the first chamfer is disposed in the second fixing hole corresponding to the second chamfer.

6. The electrical connector according to claim 4, wherein the first chamfer and the second chamfer conform to and contact each other.

7. The electrical connector according to claim 1, wherein the second fixing portion is located above the soldering portion and parallel to the soldering portion.

8. The electrical connector according to claim 1, wherein the first fixing portion and the extending arm extend in the same direction.

9. The electrical connector according to claim 1, wherein the insulating body has a protruding block located between and contacting the second fixing portion and the soldering portion.

10. The electrical connector according to claim 1, wherein the second fixing portion is disposed to extend from an extending direction of the extending arm, and the soldering portion is bent and extends downwards from the extending arm.
